(19) United States
(12) Patent Application Publication
(10) Pub. No.: US 2025/0100634 A1
(43) Pub. Date: Mar. 27, 2025

(54) VEHICLE UPPER PART STRUCTURE

(71) Applicant: TOYOTA JIDOSHA KABUSHIKI KAISHA, Toyota-shi (JP)

(72) Inventor: Masayuki OKANO, Toyota-shi (JP)

(73) Assignee: TOYOTA JIDOSHA KABUSHIKI KAISHA, Toyota-shi (JP)

(21) Appl. No.: 18/753,564

(22) Filed: Jun. 25, 2024

(30) Foreign Application Priority Data
Sep. 25, 2023 (JP) 2023-161731

(51) Int. Cl. B62D 37/02; B62D 35/00

(52) U.S. Cl. CPC B62D 37/02; B62D 35/007

(57) ABSTRACT

A vehicle upper part structure includes a clearance portion extending in the vehicle width direction on the vehicle upper side of the vehicle, a first panel disposed on the vehicle rear side of the clearance portion, and a second panel disposed on the upper surface of the first panel, and a front end portion of the first panel protruding by a predetermined length from the front end surface of the second panel is a ledge capable of reducing resonance noise caused by air flowing into the clearance portion from the vehicle front side when the vehicle travels.

### CROSS-REFERENCE TO RELATED APPLICATION

This application claims priority to Japanese Patent Application No. 2023-161731 filed on Sep. 25, 2023, incorporated herein by reference in its entirety.

### BACKGROUND

### 1. Technical Field

The present disclosure relates to a vehicle upper part structure.

2. Description of Related Art

Hitherto, a resonance noise reducing structure for a vehicle is known (see, for example, Japanese Unexamined Patent Application Publication No. 2001-225646 (JP 2001-225646 A)). The structure has an opening formed in a surface along which air flows, and a closed space formed inside the surface and connected to the opening. The structure includes a ledge offset from the surface toward the closed space on a downstream side of an airflow with respect to the opening. A length LtLt of the ledge in the airflow direction with respect to a length Ls of the opening in the airflow direction is 0.18 Ls-0.53 Ls. A height Ht of the ledge from the surface with respect to the length Ls of the opening in the airflow direction is equal to or larger than 0.17 Ls.

### SUMMARY

If the ledge for reducing the resonance noise of the vehicle during traveling of the vehicle is formed of only one member, however, machining or molding of the member is required, which complicates the manufacturing process.

Therefore, an object of the present disclosure is to provide a vehicle upper part structure in which a ledge for reducing resonance noise of a vehicle during traveling of the vehicle can be formed easily.

In order to achieve the above object, a vehicle upper part structure according to an aspect of the present disclosure includes:
a clearance portion extending in a vehicle width direction on a vehicle upper side of a vehicle;
a first panel disposed on a vehicle rear side of the clearance portion; and
a second panel disposed to overlap an upper surface of the first panel.
   A front end of the first panel protruding by a predetermined length from a front end surface of the second panel is a ledge configured to reduce resonance noise caused by air flowing into the clearance portion from a vehicle front side during traveling of the vehicle.

According to the aspect of the present disclosure, the front end of the first panel protruding by the predetermined length from the front end surface of the second panel is the ledge configured to reduce resonance noise caused by air flowing into the clearance portion from the vehicle front side during traveling of the vehicle. That is, the ledge is formed of two members that are the first panel and the second panel. Therefore, the ledge is formed more easily than in a case where the ledge is formed of only one member.

In the vehicle upper part structure according to the aspect of the present disclosure,
the clearance portion may be provided between a roof panel and a back door of the vehicle.

According to the aspect of the present disclosure, the resonance noise generated from the clearance portion provided between the roof panel and the back door of the vehicle is reduced effectively.

In the vehicle upper part structure according to the aspect of the present disclosure,
the first panel may be a rear spoiler, and
the second panel may be a rear spoiler cover.

According to the aspect of the present disclosure, the ledge is formed by using the rear spoiler and the rear spoiler cover originally included in the back door. Therefore, the ledge is formed more easily and its manufacturing cost is lower than in a case where the ledge is formed of an object other than the rear spoiler and the rear spoiler cover.

In the vehicle upper part structure according to the aspect of the present disclosure,
a length of the ledge along a vehicle front-rear direction may be ⅕ to ½ of a distance of the clearance portion along the vehicle front-rear direction.

According to the aspect of the present disclosure, the length of the ledge along the vehicle front-rear direction is ⅕ to ½ of the distance of the clearance portion along the vehicle front-rear direction. Therefore, the resonance noise generated from the clearance portion is reduced effectively.

In the vehicle upper part structure according to the aspect of the present disclosure,
a length along a vehicle up-down direction from an upper surface of the second panel to an upper surface of the ledge may be equal to or larger than ⅕ of a distance of the clearance portion along a vehicle front-rear direction.

According to the aspect of the present disclosure, the length along the vehicle up-down direction from the upper surface of the second panel to the upper surface of the ledge is equal to or larger than ⅕ of the distance of the clearance portion along the vehicle front-rear direction. Therefore, the resonance noise generated from the clearance portion is reduced effectively.

As described above, according to the present disclosure, it is possible to easily form the ledge for reducing the resonance noise of the vehicle during the traveling of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a vehicle including a vehicle upper part structure according to the present embodiment;

FIG. 2 is a schematic cross-sectional view taken along the arrow X-X in FIG. 1;

FIG. 3 is a partially enlarged schematic cross-sectional view in FIG. 2 showing a ledge according to the present embodiment;

FIG. 4 is a schematic cross-sectional view corresponding to FIG. 3 showing a ledge according to a first modification of the present embodiment;

FIG. 5 is a schematic cross-sectional view corresponding to FIG. 3 showing a ledge according to a second modification of the present embodiment; and

FIG. 6 is a schematic cross-sectional view corresponding to FIG. 3 showing a ledge according to a comparative example.

### DETAILED DESCRIPTION OF EMBODIMENTS

Hereinafter, an embodiment according to the present disclosure will be described in detail with reference to the drawings. For convenience of explanation, an arrow UP shown in the drawings is defined as a vehicle upward direction, an arrow FR is defined as a vehicle forward direction, and an arrow LH is defined as a vehicle leftward direction. Therefore, in the following description, when the vertical, front-rear, and left-right directions are described without special mention, it is assumed that the vertical direction of the vehicle, the front-rear direction of the vehicle front-rear direction, and the left-right direction (vehicle width direction) of the vehicle are indicated.

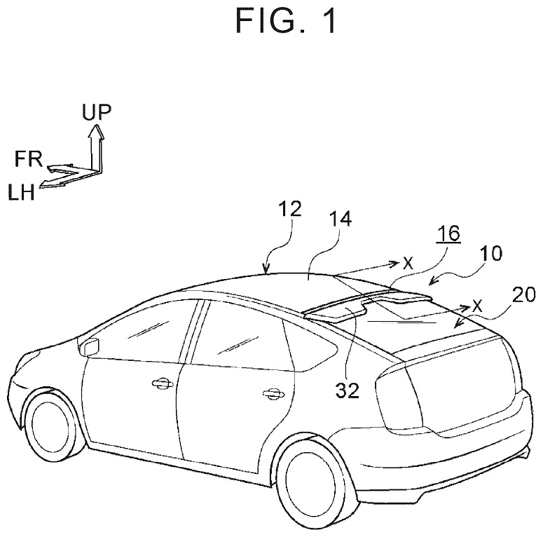

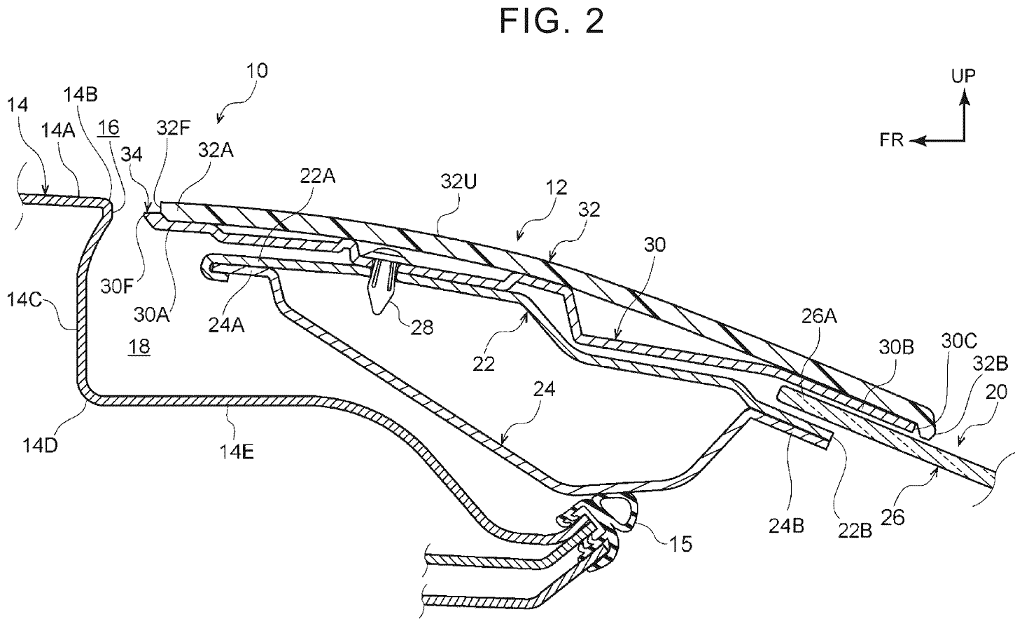

As shown in FIG. 1, a clearance portion 16 constituting the vehicle upper part structure 10 according to the present embodiment is formed between the roof panel 14 constituting the roof of the vehicle 12 and the back door 20 opening and closing the luggage compartment of the vehicle 12. That is, as shown in FIG. 2, a parting gap is formed between the rear end portion 14B on the upper surface 14A of the roof panel 14 and a front end surface 32F of a rear spoiler cover 32, which will be described later, which constitutes a part of the back door 20. The parting gap is a clearance portion 16.

The back door 20 is disposed on the rear side of the clearance portion 16, and includes a back door upper outer panel 22, a back door inside panel 24, and a back door glass 26. The upper flange portion 22A and the lower flange portion 22B are integrally formed at the upper and lower end portions of the back door upper outer panel 22, respectively. The upper flange portion 24A and the lower flange portion 24B are integrally formed at the upper end portion and the lower end portion of the back door inside panel 24, respectively.

Then, the upper flange portion 22A of the back door upper outer panel 22, and the upper flange portion 24A of the back door inside panel 24, are joined are superimposed on each other. The lower flange portion 22B of the back door upper outer panel 22, and the lower flange portion 24B of the back door inside panel 24 are joined superimposed on each other. In other words, the back door upper outer panel 22 and the back door inside panel 24, closed cross-sectional shape extending in the vehicle width direction is formed.

Further, in a side view, the rear end portion 14B of the upper surface 14A of the roof panel 14 is bent at a substantially right angle toward the lower side, and the roof panel 14 has a vertical wall portion 14C that continues from the rear end portion 14B. The lower end portion 14D of the vertical wall portion 14C is bent at a substantially right angle toward the rear side, and the roof panel 14 has an extending portion 14E that is continuous from the lower end portion 14D thereof.

The extending portion 14E of the roof panel 14 is curved downward along the lower surface of the back door inside panel 24 from the middle portion thereof, and the back door weather strip 15 is attached to the rear end portion of the extending portion 14E. The lower surface of the back door inside panel 24 is brought into pressure contact with the back door weather strip 15 to form a seal structure. As a result, a space portion 18 having a predetermined size is formed on the lower side of the clearance portion 16.

Further, a resin rear spoiler 30 as a first panel is attached to the upper side of the back door upper outer panel 22 by a fixture 28 such as a clip. The rear spoiler 30 is colored black, and is not conspicuous even if a front end portion 30F to be described later protrudes into the clearance portion 16. Further, a lower surface of the upper end portion 26A of the back door glass 26 is joined to an upper surface of the lower flange portion 22B of the back door upper outer panel 22. The rear 30B of the rear spoiler 30 covers the upper 20 end portion 26A of the back door glass 26 from above.

A resin rear spoiler cover 32 as a second panel is integrally attached to the upper surface of the rear spoiler 30. The rear spoiler cover 32 is colored in the same color as the vehicle 12, and the rear spoiler 30 is covered from above by the rear spoiler cover 32 except for the front end portion 30F thereof. Further, the rear end portion 32B of the rear spoiler cover 32 at the vehicle-width-direction center portion is bent downward so as to be close to the back door glass 26 from above, and covers the rear end surface 30C of the rear spoiler 30 from the rear side.

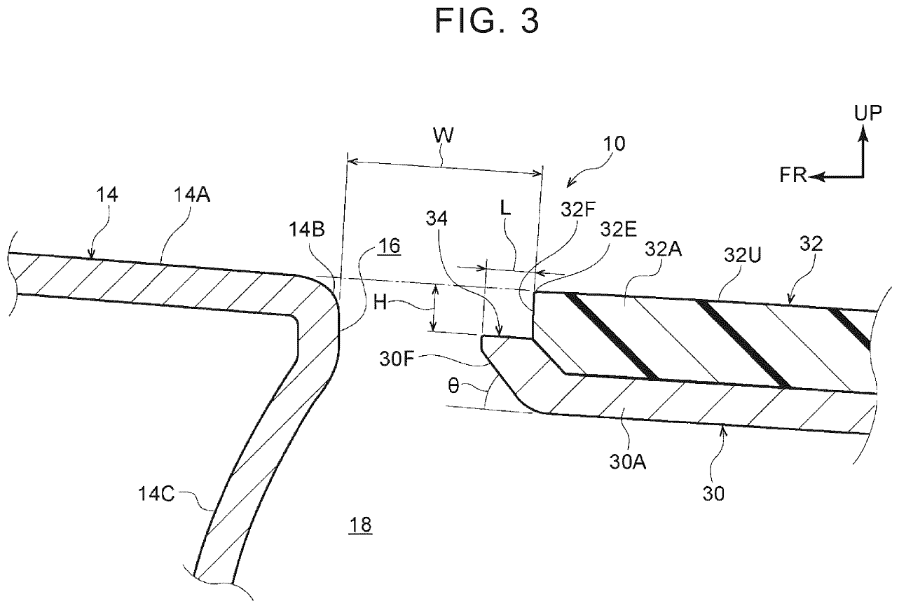

Further, the front 30A of the rear spoiler 30 and the front 32A of the rear spoiler cover 32 project forward from the front end portions of the upper flange portion 22A of the back door upper outer panel 22 and the upper flange portion 24A of the rear door inside panel 24. The upper surface 32U of the rear spoiler cover 32 is substantially flush with the upper surface 14A of the roof panel 14 (see FIG. 3).

Further, as shown in FIG. 3, the front end portion 30F of the rear spoiler 30 is bent at a predetermined angle θ to the obliquely front upper side in a side view, and protrudes at a predetermined length L to the front side of the front end surface 32F of the rear spoiler cover 32. The upper surface portion of the front end portion 30F protruding by the predetermined length L is a ledge 34 that the air that has flowed into the clearance portion 16 (space portion 18) from the front side collides, the ledge 34, so that the vortex due to the air flow is not generated on the rear side of the clearance portion 16.

The ledge 34 is formed in a flat surface shape having a normal direction as a vertical direction, and extends in the vehicle width direction. The length L of the ledge 34 along the front-rear direction is ⅕-½ of the distance W along the front-rear direction of the clearance portion 16. A length (hereinafter referred to as “height”) H along the vertical direction from the upper surface 32U of the rear spoiler cover 32 to the upper surface of the ledge 34 is ⅕ or more of a distance W along the front-rear direction of the clearance portion 16.

Specifically, the distance W in the present embodiment is W=9.4 mm, the length L is L=3.3 mm, and the height H is H=2.0 mm. Therefore, as shown in JP 2001-225646 A, the ledge 34, during the travel of the vehicle 12, it is possible to reduce the resonance noise (wind noise) by the air flowing into the clearance portion 16 (space portion 18) from the front side.

Next, the operation of the vehicle upper part structure 10 according to the present embodiment configured as described above will be described.

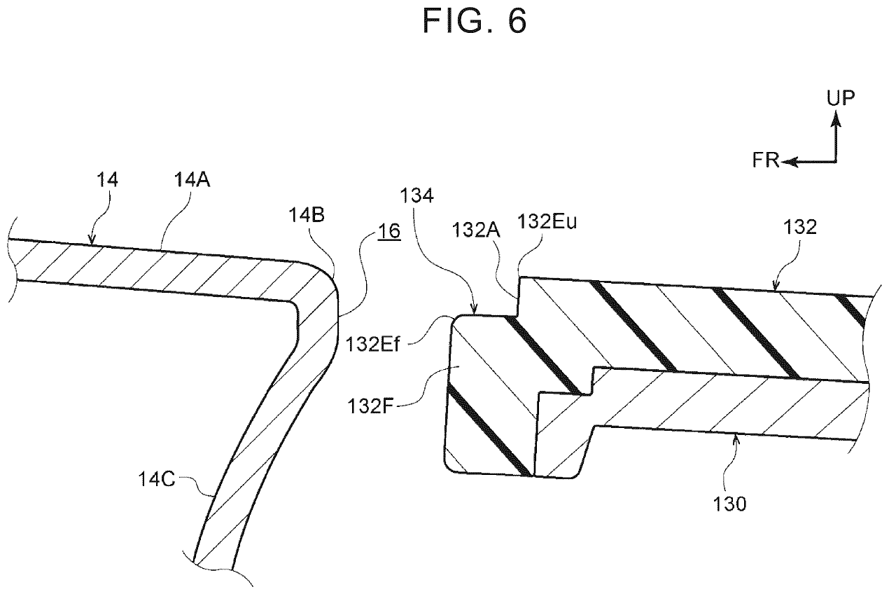

First, a comparative example will be described. As shown in FIG. 6, in this comparative example, the ledge 134 is formed only by the rear spoiler cover 132 (without using the rear spoiler 130). That is, on the upper side of the front end portion 132F of the rear spoiler cover 132, a cutout portion 132A having a substantially “L” shape in a side view is formed, and the ledge 134 is formed by the cutout portion 132A.

As described above, the ledge 134 is formed by only one member called the rear spoiler cover 132. Therefore, machining or shaping for forming the notch 132A with respect to the front end 132F of the rear spoiler cover 132 is required. The manufacturing process becomes complicated.

In contrast, in the present embodiment, as shown in FIG. 3, the ledge 34 is formed by two members of the rear spoiler 30 and the rear spoiler cover 32. Therefore, in the present embodiment, processing or molding is unnecessary as compared with the case of the comparative example in which the ledge 134 is formed by only one member called the rear spoiler cover 132. The manufacturing process is not complicated. The ledge 34 can be easily formed.

Moreover, in the present embodiment, the ledge 34 is formed using the rear spoiler 30 and the rear spoiler cover 32 originally included in the back door 20. Therefore, as compared with the case of forming the ledge 34 in other than the rear spoiler 30 and rear spoiler cover 32, it can be easily formed. Manufacturing costs can also be reduced.

Further, in the comparative example shown in FIG. 6, two edges (an upper edge 132Eu and a front edge 132Ef) extending in the vehicle-width direction are formed on the front end portion 132F of the rear spoiler cover 132 by the ledge 134, which may impair appearance. On the other hand, in the present embodiment, only the upper edge 32E (see FIG. 3) on the front end surface 32F of the rear spoiler cover 32 is not formed with an edge extending in the vehicle-width direction, and thus there is no risk of impairing the appearance. Further, since the rear spoiler 30 is black, the ledge 34 protruding to the clearance portion 16 is also not visible from the outside and is not conspicuous (appearance is not impaired).

Further, the length L of the ledge 34 along the front-rear direction is ⅕-½ (0.2-0.5) of the distance W along the front-rear direction of the clearance portion 16. The height H, which is the length along the vertical direction from the upper surface 32U of the rear spoiler cover 32 to the upper surface of the ledge 34, is equal to or greater than ⅕ (0.2) of the distance W along the front-rear direction of the clearance portion 16.

It is known as described in JP 2001-225646 A that when L is 0.2 W-0.5 W and H is equal to or higher than 0.2 W, the resonance noise caused by the air flowing into the clearance portion 16 (the space portion 18) from the front side of the vehicle 12 can be reduced. Therefore, in the present embodiment, the resonance sound generated from the clearance portion 16 formed between the roof panel 14 and the back door 20 can be effectively suppressed, and the comfort in the vehicle cabin can be improved.

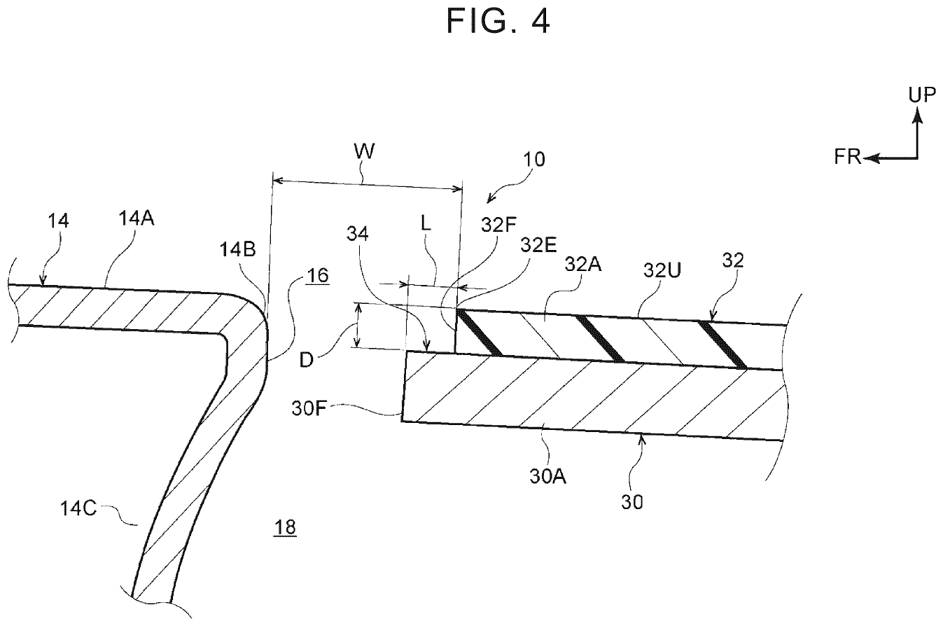

The operation of the vehicle upper part structure 10 according to the present embodiment is as described above, but the shape of the front end portion 30F of the rear spoiler 30 constituting the ledge 34 is not limited to the shape shown in FIG. 3. For example, as in the first modification shown in FIG. 4, if the thickness D of the rear spoiler cover 32 is equal to or more than ⅕ (0.2) of the distance W along the front-rear direction of the clearance portion 16, the front end portion 30F of the rear spoiler 30 may be extended by a predetermined length L from the front end surface 32F of the rear spoiler cover 32 to the front side as it is to form the ledge 34.

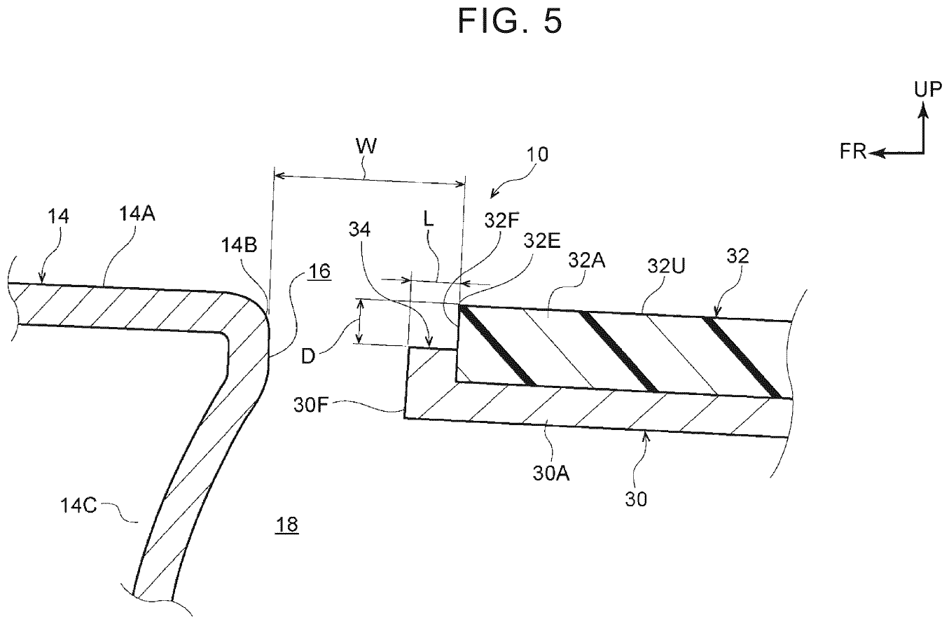

Further, for example, as in the second modification illustrated in FIG. 5, the front end portion 30F of the rear spoiler 30 may be bent at a predetermined angle θ to the obliquely front upper side in a side view, but may be bent at a substantially right angle to the upper side to form the ledge 34. As described above, the ledge 34 constituted by the front end portion 30F of the rear spoiler 30 and the front end surface 32F of the rear spoiler cover 32 may be configured as long as it satisfies the above-described dimension (length L and height H) with respect to the distance W.

Although the vehicle upper part structure 10 according to the present embodiment has been described with reference to the drawings, the vehicle upper part structure 10 according to the present embodiment is not limited to the illustrated one, and can be appropriately changed in design without departing from the gist of the present disclosure. For example, the clearance portion 16 is not limited to a configuration formed between the roof panel 14 and the back door 20 in the vehicle 12. Therefore, the first panel is the rear spoiler 30, and the second panel is not limited to the rear spoiler cover 32.

What is claimed is:

1. A vehicle upper part structure comprising:
a clearance portion extending in a vehicle width direction on a vehicle upper side of a vehicle;
a first panel disposed on a vehicle rear side of the clearance portion; and
a second panel disposed to overlap an upper surface of the first panel, wherein a front end of the first panel protruding by a predetermined length from a front end surface of the second panel is a ledge configured to reduce resonance noise caused by air flowing into the clearance portion from a vehicle front side during traveling of the vehicle.

2. The vehicle upper part structure according to claim 1, wherein the clearance portion is provided between a roof panel and a back door of the vehicle.

3. The vehicle upper part structure according to claim 2, wherein:
the first panel is a rear spoiler; and
the second panel is a rear spoiler cover.

4. The vehicle upper part structure according to claim 1, wherein a length of the ledge along a vehicle front-rear direction is ⅕ to ½ of a distance of the clearance portion along the vehicle front-rear direction.

5. The vehicle upper part structure according to claim 1, wherein a length along a vehicle up-down direction from an upper surface of the second panel to an upper surface of the ledge is equal to or larger than ⅕ of a distance of the clearance portion along a vehicle front-rear direction.
